(19) United States
(12) Patent Application Publication
(10) Pub. No.: US 2025/0303205 A1
(43) Pub. Date: Oct. 2, 2025

(54) System and Method for Detecting Fall Event

(71) Applicant: 3M INNOVATIVE PROPERTIES COMPANY, St. Paul, MN (US)

(72) Inventors: Ronald D. Jesme, Plymouth, MN (US); Jonathan J. Lepp, Eagan, MN (US); Daniel B. Taylor, White Bear Lake, MN (US); Travis W. Rasmussen, Rosemount, MN (US)

(21) Appl. No.: 18/866,683

(22) PCT Filed: Jun. 12, 2023
(86) PCT No.: PCT/IB2023/056040

§ 371 Date: Nov. 18, 2024

Related U.S. Application Data
(60) Provisional application No. 63/366,509, filed on Jun. 16, 2022.

(51) Int. Cl. A62B 35/00; G08B 21/04

(52) U.S. Cl. CPC A62B 35/0093; A62B 35/0075; G08B 21/0461

(57) ABSTRACT

The present disclosure provides a system for detecting and alerting of a fall event of a user using an article of personal protective equipment (PPE). The system includes a switching unit configured to be mechanically actuated from an inactive configuration to an active configuration. The switching unit is normally disposed in the inactive configuration until the switching unit is mechanically actuated to the active configuration. The system further includes a mechanical unit mechanically coupling the switching unit to the article of PPE. The mechanical unit mechanically actuates the switching unit from the inactive configuration to the active configuration upon a predetermined movement of the article of PPE corresponding to the fall event of the user. The system further includes an electronic circuit disposed in an off state when the electronic circuit is not electrically powered and disposed in an on state when the electronic circuit is electrically powered.

### TECHNICAL FIELD

The present disclosure relates generally to a system and a method for detecting and alerting of a fall event of a user using an article of personal protective equipment (PPE).

### BACKGROUND

Fall protection equipment is an important safety equipment for users operating at potentially harmful or even deadly heights. For example, to help ensure safety in a fall event, users often wear safety harnesses connected to support structures with fall protection equipment, such as lanyards, energy absorbers, self-retracting lifelines (SRLs), descenders, and the like. When a user is connected to a support structure, the user may be referred to as being “tied off” or “anchored.” To maintain a safe working condition when working at heights, the user must always maintain at least one connection to a support structure.

Fall protection equipment may include a variety of components for connecting the user to the support structure (also referred to as an anchorage). For example, snap hooks and connectors (e.g., carabiners) may have moveable gates that allow the user to connect to and disconnect from the support structure. In another example, a ladder safety sleeve may have a moveable gate that allows the user to connect to and disconnect from a climbing ladder fall arrest system carrier, e.g., a flexible cable or a rigid rail support structure.

In case of a fall event of a user using the fall protection equipment, there is a need for automatic generation of an alarm or a notification, such that a safety officer or a central server may receive the information of the fall event.

### SUMMARY

In a first aspect, the present disclosure provides a system for detecting a fall event of a user using an article of personal protective equipment (PPE). The system includes a switching unit configured to be mechanically actuated from an inactive configuration to an active configuration. The switching unit is normally disposed in the inactive configuration until the switching unit is mechanically actuated to the active configuration. The system further includes a mechanical unit mechanically coupling the switching unit to the article of PPE. The mechanical unit mechanically actuates the switching unit from the inactive configuration to the active configuration upon a predetermined movement of the article of PPE corresponding to the fall event of the user. The system further includes an electronic circuit disposed in an off state when the electronic circuit is not electrically powered and disposed in an on state when the electronic circuit is electrically powered. In the on state, the electronic circuit generates an output indicative of the fall event of the user. The system further includes a power source configured to selectively electrically power the electronic circuit based on a configuration of the switching unit. In the inactive configuration of the switching unit, the power source does not electrically power the electronic circuit, such that the electronic circuit is in the off state. In the active configuration of the switching unit, the power source electrically powers the electronic circuit, such that the electronic circuit switches from the off state to the on state and generates the output.

In a second aspect, the present disclosure provides an article of PPE including the system of the first aspect.

In a third aspect, the present disclosure provides a method for detecting a fall event of a user using an article of personal protective equipment (PPE). The method includes providing a switching unit configured to be mechanically actuated from an inactive configuration to an active configuration. The switching unit is normally disposed in the inactive configuration until the switching unit is mechanically actuated to the active configuration. The method further includes providing a mechanical unit mechanically coupling the switching unit to the article of PPE. The method further includes providing an electronic circuit disposed in an off state when the electronic circuit is not electrically powered and disposed in an on state when the electronic circuit is electrically powered. The method further includes providing a power source configured to selectively electrically power the electronic circuit based on a configuration of the switching unit. In the inactive configuration of the switching unit, the power source does not electrically power the electronic circuit, such that the electronic circuit is in the off state. The method further includes mechanically actuating, via the mechanical unit, the switching unit from the inactive configuration to the active configuration upon a predetermined movement of the article of PPE corresponding to the fall event of the user. The method further includes actuating, via the switching unit, the power source to electrically power the electronic circuit upon being mechanically actuated from the inactive configuration to the active configuration. The method further includes switching the electronic circuit from the off state to the on state upon being electrically powered by the power source. The method further includes generating, via the electronic circuit, an output indicative of the fall event of the user upon being switched from the off state to the on state.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIGS. 1A and 1B are block diagrams of a system for detecting a fall event of a user using an article of personal protective equipment (PPE), according to an embodiment of the present disclosure;

FIG. 2A is a block diagram of a system for detecting the fall event of the user using the article of PPE, according to another embodiment of the present disclosure:

FIG. 2B is a block diagram of an article of PPE comprising the system of FIGS. 1A and 1B, according to an embodiment of the present disclosure;

FIGS. 3A and 3B are schematic diagrams of the system of FIGS. 1A and 1B, according to an embodiment of the present disclosure;

FIGS. 4A and 4B are schematic diagrams of a system for detecting the fall event of the user using the article of PPE, according to another embodiment of the present disclosure;

FIGS. 5A and 5B are schematic diagrams of a system for detecting the fall event of the user using the article of PPE, according to another embodiment of the present disclosure;

FIGS. 6A and 6B are schematic diagrams of a system for detecting the fall event of the user using the article of PPE, according to another embodiment of the present disclosure;

FIGS. 7A and 7B are schematic diagrams of the system of FIGS. 1A and 1B, according to another embodiment of the present disclosure;

FIG. 8 is a graph illustrating a capacity of a power source of the system of FIGS. 7A and 7B versus storage time, according to an embodiment of the present disclosure;

FIGS. 9A and 9B are schematic diagrams of the system of FIGS. 1A and 1B, according to yet another embodiment of the present disclosure;

FIGS. 10A and 10B are schematic diagrams of a system for detecting the fall event of the user using the article of PPE, according to another embodiment of the present disclosure;

FIGS. 11A and 11B are schematic diagrams of a system for detecting the fall event of the user using the article of PPE, according to another embodiment of the present disclosure;

FIGS. 12A and 12B are schematic diagrams of a system for detecting the fall event of the user using the article of PPE, according to another embodiment of the present disclosure; and

FIG. 13 is a flowchart of a method for detecting the fall event of the user using the article of PPE, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably. The term “about”, unless otherwise specifically defined, means to a high degree of approximation (e.g., within +/−5% for quantifiable properties) but again without requiring absolute precision or a perfect match.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

As used herein, “at least one of A and B” should be understood to mean “only A, only B, or both A and B”.

As used herein, the term “mechanical actuation” may include without limitation pneumatic. hydraulic, gear drive, belt drive, lever, spring, knob, cable, shear pin, and the like.

The term “mechanically coupled” may include direct physical connections between two or more components, or indirect physical connections between two or more components that are connected together by one or more additional components. For example, a first component may be mechanically coupled to a second component by being directly connected together or by being connected by a third component.

As used herein, the term “an article of personal protective equipment (PPE)” may include any type of fall protection equipment that is used to connect a user to a support structure for the purpose of securing the user to the support structure in the event of a fall. Examples of fall protection equipment include a variety of connectors (also referred to as “spring hooks” or “snap hooks” or carabiners), anchorage connectors, cable sleeves, davits, harnesses, vertical and horizonal lifelines, self-retracting lifelines (SRLs). lanyards, or other devices capable of connecting the user to and disconnecting the user from the support structure. A particular example of a connector that may be adapted to incorporate certain techniques of this disclosure is the Comfort Grip Connector™ Snap Hook manufactured by 3M Fall Protection Business. A particular example of a cable sleeve that may be adapted to incorporate certain techniques of this disclosure is the Lad-Saf™ X3 Detachable Cable Sleeve manufactured by 3M Fall Protection Business. A support structure may include an anchor or another structure capable of supporting the user in the event of a fall.

The present disclosure relates to a system and a method for detecting and alerting of a fall event of a user using an article of personal protective equipment (PPE). The system of the present disclosure is particularly used for detection of fall events of users working at potentially dangerous heights. The article of PPE may be full body harnesses, hooks and connectors, lanyards. SRLs, anchorage connectors, fixed line systems, or any combinations thereof.

Generally, when a user experiences a fall event, a prompt rescue plan is needed to provide any required medical attention and prevent any further injury. However, in some cases, it can be difficult to know when a fall event has occurred due to remote locations, loud environments, obstructed views, and the like.

Therefore, there exists a need for a system and a method by which an alarm or an alert is generated automatically whenever there is a fall event of a user working at potentially dangerous heights.

The present disclosure provides a system for detecting a fall event of a user using an article of PPE. The system includes a switching unit configured to be mechanically actuated from an inactive configuration to an active configuration. The switching unit is normally disposed in the inactive configuration until the switching unit is mechanically actuated to the active configuration. The system further includes a mechanical unit mechanically coupling the switching unit to the article of PPE. The mechanical unit mechanically actuates the switching unit from the inactive configuration to the active configuration upon a predetermined movement of the article of PPE corresponding to the fall event of the user. The system further includes an electronic circuit disposed in an off state when the electronic circuit is not electrically powered and disposed in an on state when the electronic circuit is electrically powered. In the on state, the electronic circuit generates an output indicative of the fall event of the user. The system further includes a power source configured to selectively electrically power the electronic circuit based on a configuration of the switching unit. In the inactive configuration of the switching unit, the power source does not electrically power the electronic circuit, such that the electronic circuit is in the off state. In the active configuration of the switching unit, the power source electrically powers the electronic circuit, such that the electronic circuit switches from the off state to the on state and generates the output.

As the mechanical unit mechanically couples the switching unit to the article of PPE, the mechanical unit actuates the switching unit from the inactive configuration to the active configuration upon occurrence of the fall event of the user. Once the switching unit is actuated to the active configuration, the power source starts to deliver electrical power to the electronic circuit thereby generating the output indicative of the fall event of the user. The output includes at least one of an audio signal, a text message. a visual signal, and a haptic signal. In some cases, the output may include alerts or notifications on mobile phones and their mobile applications. In some cases, the output may include radio signals including but not limited to Bluetooth, Bluetooth Low Energy (BLE). Zigbee. Wi-Fi. LoRa, cellular or other wireless protocols of the like that are transmitted to one or more predefined addresses. For example, the output may include Bluetooth signals that could generate alerts on mobile phones or wearables. In some cases, the output may be transmitted to one or more articles of PPE associated with other workers. For example, the output may include audible alerts transmitted to a hearing protector communication headset, such as 3M™ Peltor™ WS™ ProTac XPI Headsets from 3M Company. St. Paul, Minnesota. For example, the output may include Wi-Fi signals that could be tied to Cloud applications where the alert could be any number of cloud related services (e.g., website dashboards, emails, texts. etc.).

Therefore, upon detecting the fall event of the user, the system of the present disclosure automatically sends or generates the output/alert to a central server, a cloud, or a safety officer, or multiple destinations. Hence, the system of the present disclosure can detect and alert the fall event of the user. The output is generated even if the fall event is not known to any person other than the user. As the output is generated as soon as the fall event is detected, the system of the present disclosure may help the user to be rescued at a faster rate thereby preventing injury from happening in the first place. In other words, upon the fall event of the user, a timely and faster rescue and/or descent operation may be conducted. This may prevent the user against suspension trauma and injury after the fall event of the user. Further, as the output is generated as soon as the fall event is detected, the system of the present disclosure may help the user to receive immediate and required medical attention in case of any critical injury. In some cases, two or more persons are needed for successfully conducting a rescue operation after the fall event of the user. Therefore. by automatically generating the output upon detecting the fall event of the user, the system of the present disclosure may protect the user from a life-threatening condition as he/she may receive the timely medical treatment.

Upon detecting the fall event of the user, the system of the present disclosure may send real time alerts to the safety officer or the server without requiring additional infrastructure at a worksite. Further. as the electronic circuit generates the output only when the power source electrically powers the electronic circuit upon occurrence of the fall event of the user, the system of the present disclosure may have a long service life free of maintenance. In some cases, the power source has a shelf life of at least 10 years. Further, the system may be integrated into or attached to a new or existing article of PPE used by the user without adding substantial cost. Moreover, the system of the present disclosure may provide a reliable means to generate the output indicative of the fall event of the user.

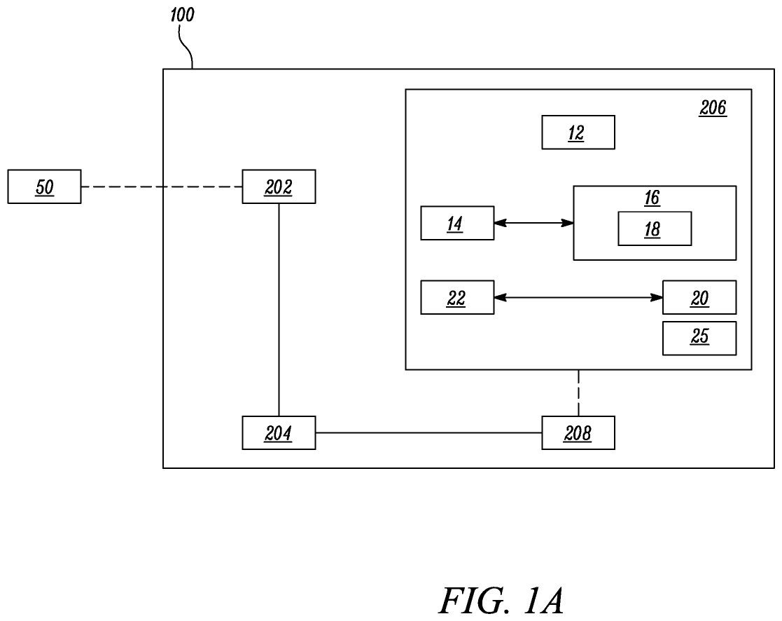

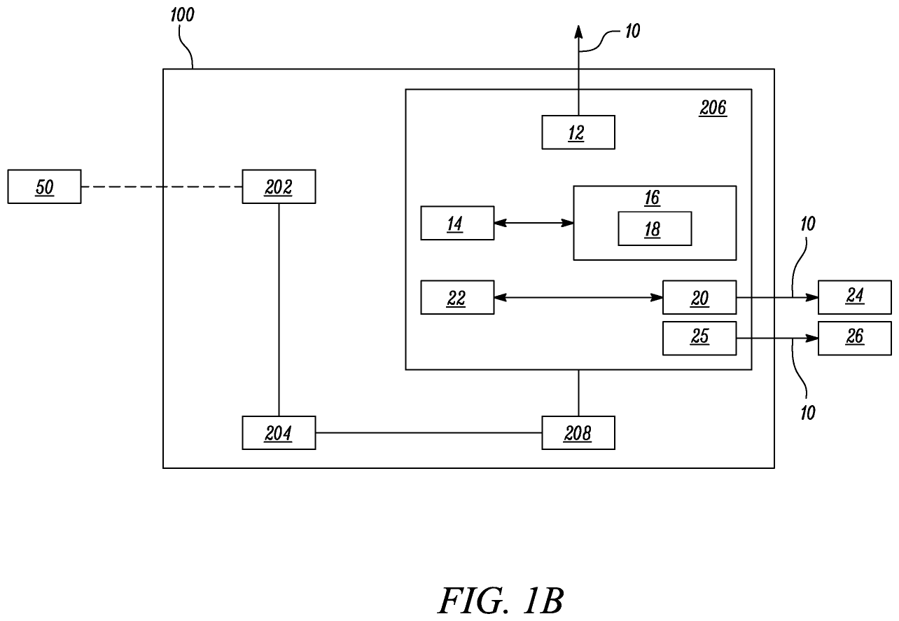

Referring now to Figures. FIGS. 1A and 1B are block diagrams of a system 100 for detecting a fall event of a user (not shown) using an article of personal protective equipment (PPE) 50, according to an embodiment of the present disclosure. The article of PPE 50 is used by the user within one or more physical environments, which may include but is not limited to construction sites, mining or manufacturing sites. In some embodiments, the article of PPE 50 includes fall protection equipment. For example, the article of PPE 50 may be a combination of one or more of lanyards, connectors, anchorage connectors, lifelines, body harnesses, or the like.

The system 100 includes a switching unit 204 configured to be mechanically actuated from an inactive configuration to an active configuration. In the illustrated embodiment of FIG. 1A, the switching unit 204 is in the inactive configuration. In the illustrated embodiment of FIG. 1B, the switching unit 204 is in the active configuration. The switching unit 204 is normally disposed in the inactive configuration until the switching unit 204 is mechanically actuated to the active configuration. The switching unit 204 may be a valve, a rotating part, a reciprocating part, a separating part, a tool, or any other movable component. Various examples of the switching unit 204 will be described later in the description.

The system 100 further includes a mechanical unit 202 mechanically coupling the switching unit 204 to the article of PPE 50. The mechanical unit 202 mechanically actuates the switching unit 204 from the inactive configuration to the active configuration upon a predetermined movement of the article of PPE 50 corresponding to the fall event of the user. The predetermined movement of the article of PPE 50 may be any rotational or translational movement of the article of PPE 50 upon the fall event of the user. In some cases, the predetermined movement of the article of PPE 50 may be linear and/or non-linear movement of the article of PPE 50 upon the fall event of the user. In some embodiments, the mechanical unit 202 includes at least one of a mechanical linkage, a gear drive, a friction drive, a cable, and a connecting cord. The article of PPE 50 is mechanically coupled to the mechanical unit 202.

The system 100 further includes an electronic circuit 206 disposed in an off state when the electronic circuit 206 is not electrically powered and disposed in an on state when the electronic circuit 206 is electrically powered. In the illustrated embodiment of FIG. 1A, the electronic circuit 206 is not electrically powered and therefore disposed in the off state. In the illustrated embodiment of FIG. 1B, the electronic circuit 206 is electrically powered and therefore disposed in the on state. In the on state, the electronic circuit 206 generates an output 10 indicative of the fall event of the user. In some embodiments, the output 10 includes at least one of an audio signal, a text message, a visual signal, and a haptic signal.

In some cases, the output 10 may include alerts or notifications on mobile phones and their mobile applications. The output 10 may be transmitted to a central server, a cloud, or a safety officer, or multiple destinations. In some cases, the output 10 may include radio signals including but not limited to Bluetooth. Bluetooth Low Energy (BLE). Zigbee. Wi-Fi. LoRa, cellular or other wireless protocols of the like that are transmitted to one or more predefined addresses. For example, the output 10 may include Bluetooth signals that could generate alerts on mobile phones or wearables. In some cases, the output may be transmitted to one or more articles of PPE associated with other workers. For example, the output may include audible alerts transmitted to a hearing protector communication headset, such as 3M™ Peltor™ WS™ ProTac XPI Headsets from 3M Company. St. Paul, Minnesota. For example, the output 10 may include Wi-Fi signals that could be tied to Cloud applications where the alert could be any number of cloud related services (e.g., website dashboards, emails, texts, etc.).

The system 100 further includes a power source 208 configured to selectively electrically power the electronic circuit 206 based on a configuration of the switching unit 204. In the inactive configuration of the switching unit 204 illustrated in FIG. 1A, the power source 208 does not electrically power the electronic circuit 206, such that the electronic circuit 206 is in the off state. Thus, the electronic circuit 206 is not electrically powered by the power source 208. In the active configuration of the switching unit 204 illustrated in FIG. 1B, the power source 208 electrically powers the electronic circuit 206, such that the electronic circuit 206 switches from the off state to the on state and generates the output 10, thus, the electronic circuit 206 becomes electrically powered by the power source 208.

In some embodiments, the electronic circuit 206 includes at least one electronic component 12 configured to generate the output 10. In some embodiments, the at least one electronic component 12 includes one or more of a speaker, a vibration device, a light emitting diode, a buzzer, and a message generator. In some embodiments, the electronic circuit 206 includes a processor 14 and a memory 16 communicably coupled to the processor 14 and configured to store at least one parameter 18. The at least one parameter 18 includes one or more of a serial number associated with the article of PPE 50, a unique identification number of the user, one or more instructions executable by the processor 14, and one or more destination addresses of the output 10. The one or more instructions may be executed by the processor 14 to control the at least one electronic component 12 in order to generate the output 10. The one or more instructions may be stored in the memory 16 of the electronic circuit 206. The output 10 may sometimes include the at least one parameter 18, such as the unique identification number of the user, the serial number associated with the article of PPE 50, and so on.

In some embodiments, the electronic circuit 206 includes a cell phone modem 20 configured to transmit the output 10. In some embodiments, the electronic circuit 206 further comprises a global positioning system (GPS) receiver 22 configured to determine a location of the fall event of the user. In some embodiments, the cell phone modem 20 is configured to transmit the output 10 to a predefined destination 24. The location of the fall event of the user is embedded in the output 10. Specifically, the location of the fall event of the user is embedded in the output 10 via the electronic circuit 206. In some embodiments, a time of the fall event of the user may also be embedded in the output 10. In such cases,

once the output 10 (with location and time of the fall event of the user) is transmitted to the predefined destination 24, a timely and effective rescue operation can be planned thereby preventing the user from any critical injury. The inclusion of the location and time in the output 10 may help a rescue team to reach the location of the user and conduct the rescue operation even at remote locations, such as wind towers.

By transmitting the output 10, the cell phone modem 20 may send real time alerts to the predefined destination 24. A particular example of the cell phone modem 20 that may be adapted to the system 100 is “Boron LTE CAT-M1 (NorAm) Starter Kit with EtherSIM” manufactured by Particle Industries, Inc. For such a device, cell phone plans for the cell phone modem 20 may be inexpensive by reason of data rate limitations. Further, some of the plans of the cell phone modem 20 may have no time limit for calling.

In some embodiments, the electronic circuit 206 is further configured to determine the location of the fall event of the user based on at least one of Bluetooth direction finding, geofencing, and Wi-Fi connection with one or more access points (not shown). The one or more access points may be located in a server or a warehouse. In some embodiments, the electronic circuit 206 includes a communication device 25 configured to establish a wireless connection with the one or more access points. In some cases, the electronic circuit 206 may use Bluetooth direction finding operation to detect the angle of arrival/departure of a Bluetooth signal sent the communication device 25 to a computing device (not shown) to determine the location of the fall event of the user. In some cases, the electronic circuit 206 may determine a geofencing location of the fall event of the user. Moreover, a Wi-Fi connection of the communication device 25 with the one or more access points can be used to determine the location of the fall event of the user via triangulation. The location of the fall event of the user is embedded in the output 10. The electronic circuit 206 is further configured to transmit the output to a predefined destination 26. In other words, the communication device 25 in configured to transmit the output to the predefined destination 26.

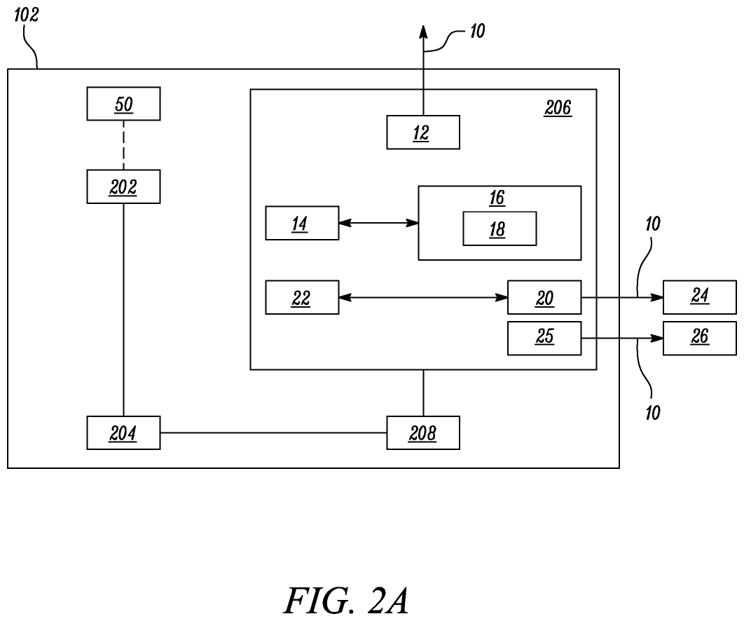

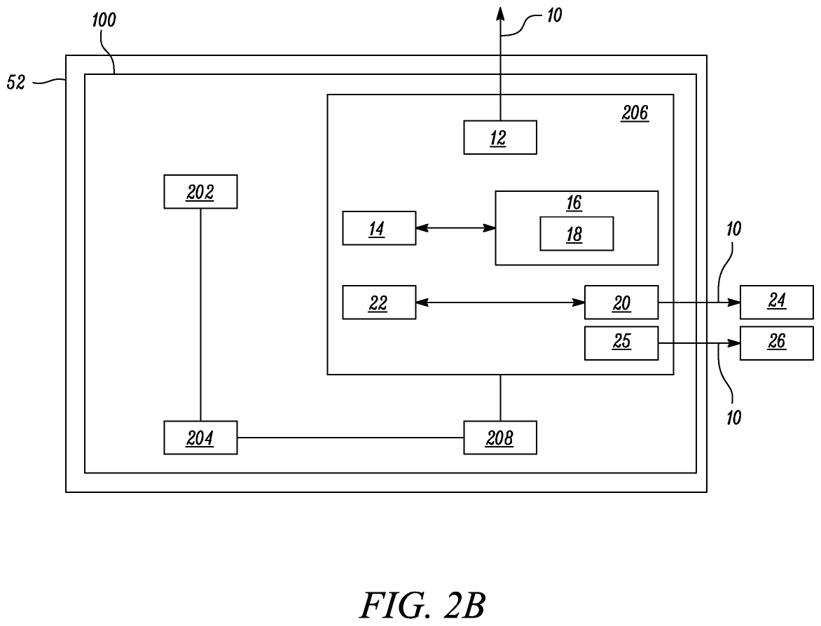

FIG. 2A is a block diagram of a system 102 for detecting the fall event of the user using the article of PPE 50, according to another embodiment of the present disclosure. The system 102 is substantially similar to the system 100 illustrated in FIGS. 1A and 1B. Common components between the system 100 and the system 102 are illustrated by the same reference numerals. However, the system 102 includes the article of PPE 50 mechanically coupled to the mechanical unit 202. In other words, the article of PPE 50 is a part of the system 102. In the illustrated embodiment of FIG. 2A, the switching unit 204 is in the active configuration. As the switching unit 204 is in the active configuration, the electronic circuit 206 is electrically powered by the power source 208 and therefore disposed in the on state.

In some embodiments, the mechanical unit 202 is configured to detach from the article of PPE 50 upon the predetermined movement of the article of PPE 50. Therefore, upon occurrence of the fall event of the user, the mechanical unit 202 is configured to detach from the article of PPE 50. Further, the mechanical unit 202 mechanically actuates the switching unit 204 from the inactive configuration to the active configuration upon detachment of the mechanical unit 202 from the article of PPE 50. In some embodiments, the mechanical unit 202 is configured to deform upon the predetermined movement of the article of PPE 50. Therefore, upon occurrence of the fall event of the user, the mechanical unit 202 is configured to deform. Further, the mechanical unit 202 mechanically actuates the switching unit 204 from the inactive configuration to the active configuration upon deformation of the mechanical unit 202.

FIG. 2B is a block diagram of an article of PPE 52 including the system 100 illustrated in FIGS. 1A and 1B, according to an embodiment of the present disclosure. In some embodiments, the article of PPE 52 also includes fall protection equipment, such as one or more of lanyards, anchorage connectors. connectors, lifelines, body harnesses, or combination thereof.

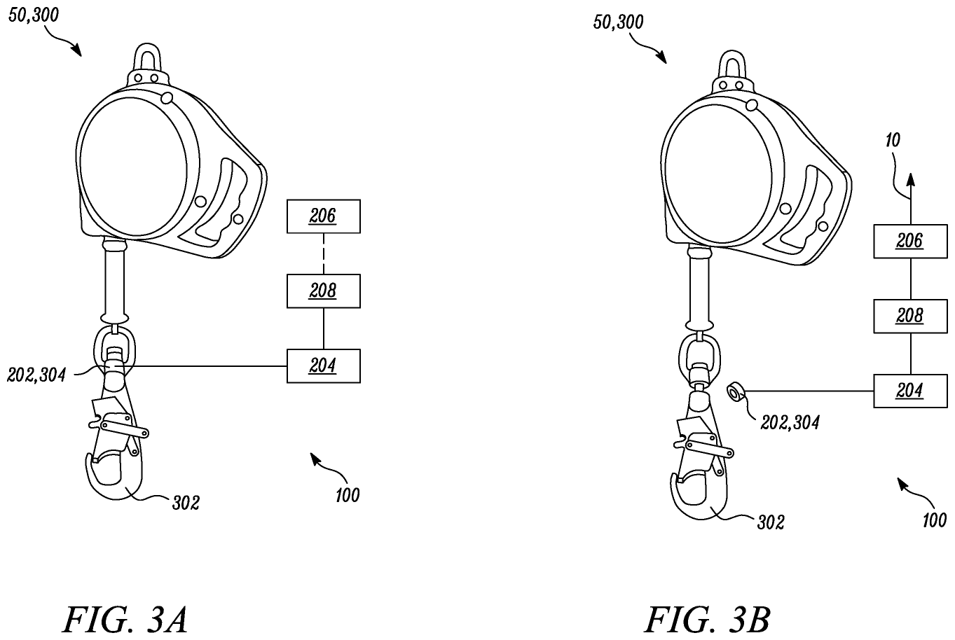

FIGS. 3A and 3B are schematic diagrams of the system 100 illustrated in FIGS. 1A and 1B. according to an embodiment of the present disclosure. In the illustrated embodiment of FIGS. 3A and 3B. the article of PPE 50 includes a self-retracting lifeline (SRL) 300 having a snap hook 302. As illustrated in FIG. 3A, the mechanical unit 202 includes a ferrule 304 normally attached to the snap hook 302. Further. as illustrated in FIG. 3B, the ferrule 304 detaches from the snap hook 302 upon the predetermined movement of the article of PPE 50. In other words, the ferrule 304 detaches from the snap hook 302 upon occurrence of the fall event of the user or upon the predetermined movement of the SRL 300. Once the mechanical unit 202 (i.e., the ferrule 304) detaches from the snap hook 302, the mechanical unit 202 mechanically actuates the switching unit 204 from the inactive configuration to the active configuration. The mechanical unit 202 may be connected to the switching unit 204 via a mechanical linkage. Once the switching unit 204 is mechanically actuated from the inactive configuration to the active configuration, the power source 208 delivers the electrical power to the electronic circuit 206 and the electronic circuit 206 is disposed in the on state. Hence, upon detachment of the ferrule 304 from the snap hook 302 of the SRL 300, the electronic circuit 206 is disposed in the on state and generates the output 10 indicative of the fall event of the user. It should be understood here that the technique applied with reference to FIGS. 3A and 3B may be applied to a variety of fall protection equipment in addition to the SRL 300. In some embodiments, such a mechanical unit 202 (i.e., the ferrule 304) may also be attached to, but not limited to twin-leg setups of SRLs and lanyards. In some cases, each of the legs of the twin-leg setups may comprise the ferrule 304. In some other cases, only one of the legs of the twin-leg setups may comprise the ferrule 304 shown in FIGS. 3A and 3B.

In some cases, the ferrule 304 deforms upon the predetermined movement of the article of PPE 50. Once the ferrule 304 deforms, the ferrule 304 mechanically actuates the switching unit 204 from the inactive configuration to the active configuration and therefore, the electronic circuit 206 is disposed in the on state. as illustrated in FIG. 3B.

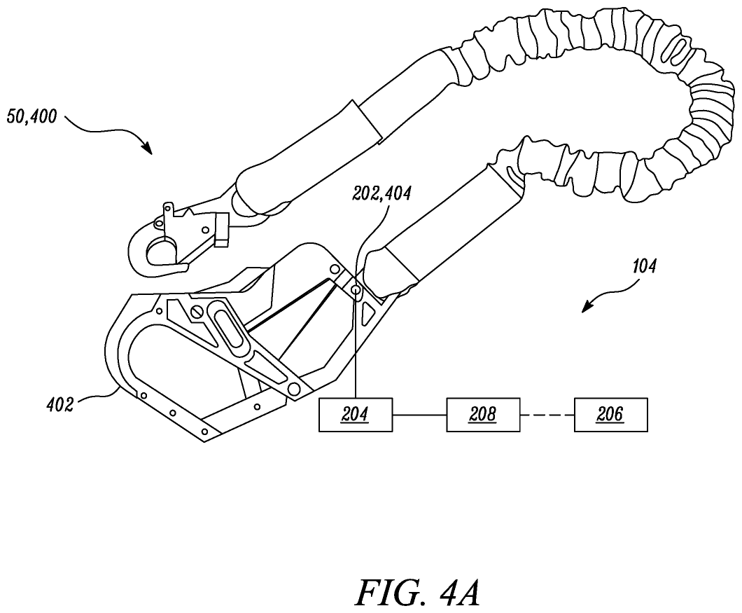

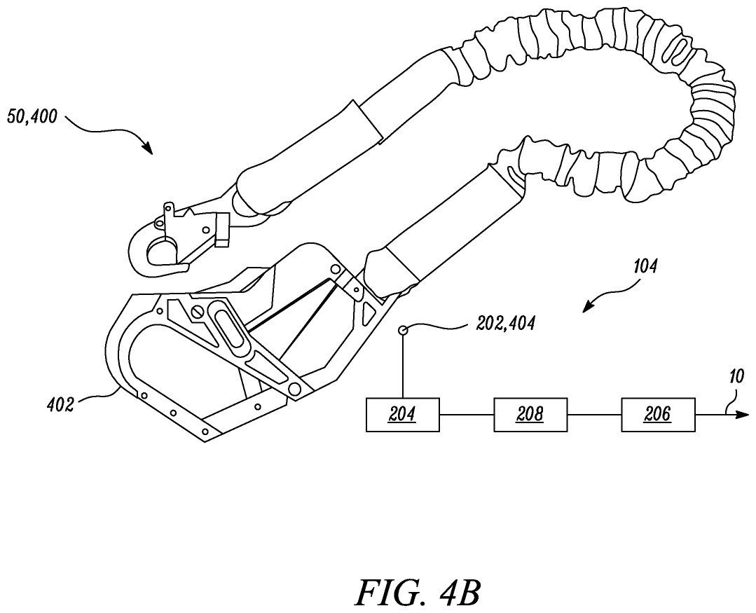

FIGS. 4A and 4B are schematic diagrams of a system 104, according to another embodiment of the present disclosure. The system 104 is functionally equivalent to the system 100 illustrated in FIGS. 3A and 3B. Common components between the system 100 and the system 104 are illustrated by the same reference numerals. In the illustrated embodiment of FIGS. 4A and 4B, the article of PPE 50 includes a lanyard 400 including a connector 402. Specifically, the lanyard 400 is a single-leg shock absorbing lanyard. In some embodiments, the article of PPE 50 may be a twin-leg lanyard. As illustrated in FIG. 4A. the mechanical unit 202 includes a pin 404 normally attached to the connector 402. As illustrated in FIG. 4B, the pin 404 detaches from the connector 402 upon the predetermined movement of the article of PPE 50. In other words, the pin 404 detaches from the connector 402 upon occurrence of the fall event of the user or upon the predetermined movement of the lanyard 400.

Once the mechanical unit 202 (i.e., the pin 404) detaches from the connector 402, the mechanical unit 202 mechanically actuates the switching unit 204 from the inactive configuration to the active configuration. Hence, upon detachment of the pin 404 from the connector 402 of the lanyard 400, the electronic circuit 206 is disposed in the on state and generates the output 10 indicative of the fall event of the user.

In some cases, the pin 404 deforms upon the predetermined movement of the article of PPE 50. Once the pin 404 deforms, the pin 404 mechanically actuates the switching unit 204 from the inactive configuration to the active configuration and therefore, the electronic circuit 206 is disposed in the on state. as illustrated in FIG. 4B.

In some embodiments, the mechanical unit 202 (i.e., the pin 404 shown in FIGS. 4A and 4B) may also be attached to, but not limited to twin-leg setups of SRLs and lanyards. In some cases, the pin 404 may be attached to each of the legs of the twin-leg setups. In some other cases, the pin 404 may be attached to only one of the legs of the twin-leg setups.

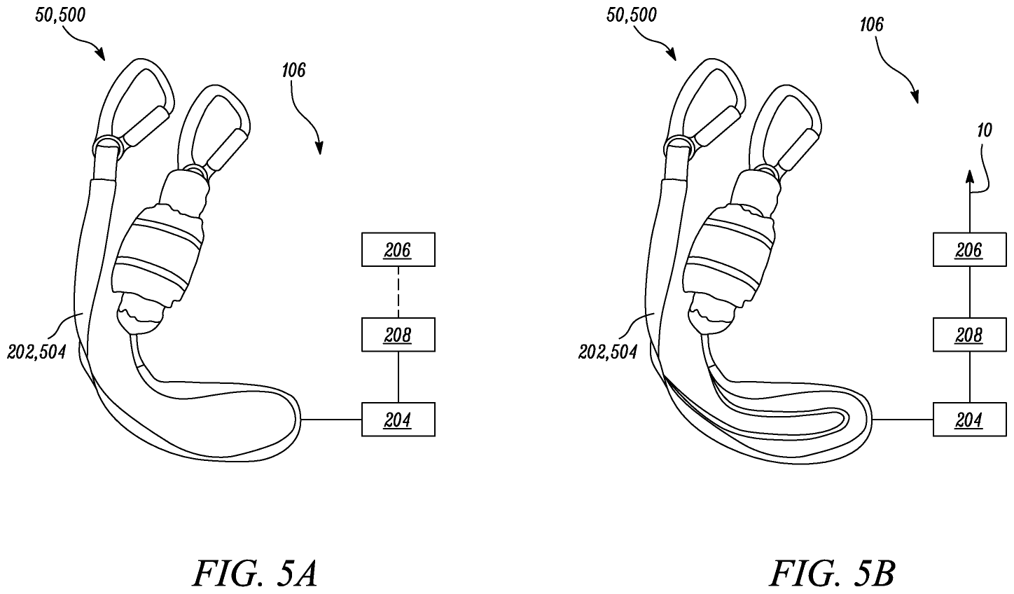

FIGS. 5A and 5B are schematic diagrams of a system 106, according to another embodiment of the present disclosure. The system 106 is functionally equivalent to the system 100 illustrated in FIGS. 3A and 3B. Common components between the system 100 and the system 106 are illustrated by the same reference numerals. However, in the system 106, the mechanical unit 202 includes a webbing 504 attached to the article of PPE 50. In the illustrated embodiment of FIGS. 5A and 5B, the article of PPE 50 includes a lanyard 500 having the webbing 504.

As illustrated in FIG. 5A, the switching unit 204 is in the inactive configuration when the webbing 504 is normally disposed in an intact configuration. As illustrated in FIG. 5B, the webbing 504 at least partially tears (or deforms) from the intact configuration upon the predetermined movement of the article of PPE 50 (i.e., the lanyard 500). In other words, the webbing 504 at least partially tears upon occurrence of the fall event of the user or upon the predetermined movement of the lanyard 500. The webbing 504 mechanically actuates the switching unit 204 from the inactive configuration to the active configuration upon tearing from the intact configuration. Hence, upon tearing of the webbing 504 from its intact configuration, the electronic circuit 206 is disposed in the on state and generates the output 10 indicative of the fall event of the user.

In some cases, the mechanical unit 202 that at least partially tears upon occurrence of the fall event of the user may be included in a safety harness. Thus, the mechanical unit 202 that at least partially tears upon occurrence of the fall event of the user may be a component of the fall protection equipment, such as, but no limited to a shock pack, a single-leg lanyard, a double-leg lanyard, safety harnesses, and the like. In some cases, one such mechanical unit 202 may be disposed on a harness and another such mechanical unit 202 may be disposed on the single-leg lanyard. In some other cases, one such mechanical unit 202 may be disposed on the harness and another such mechanical unit 202 may be disposed on the double-leg lanyard. In some cases, one such mechanical unit 202 may be disposed on one of the legs of the double-leg lanyard and another such mechanical unit 202 may be disposed on other of the legs of the double-leg lanyard.

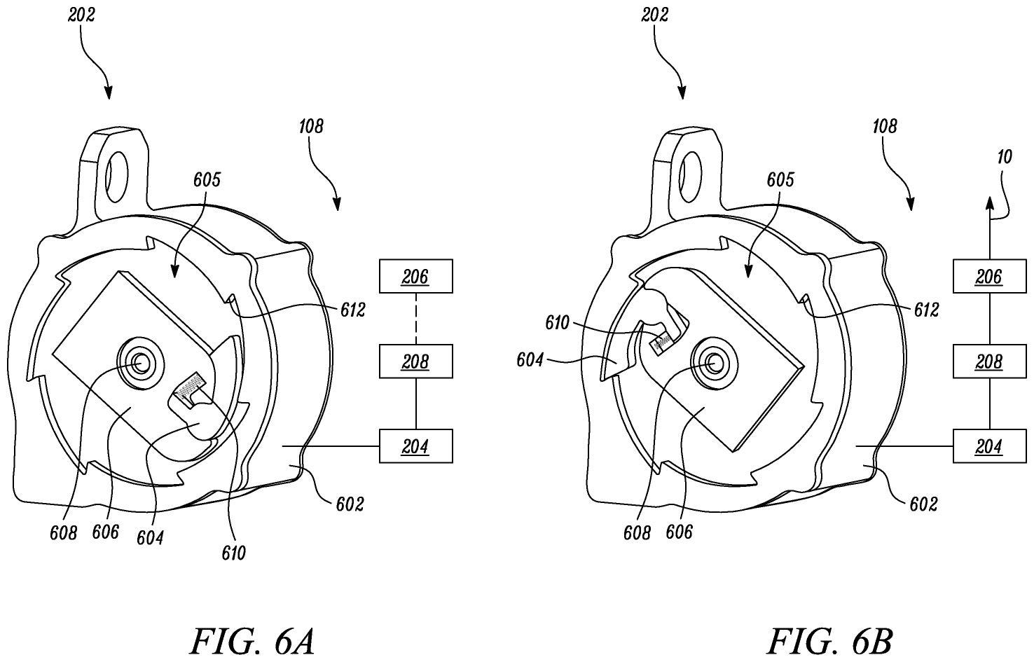

FIGS. 6A and 6B are schematic diagrams of a system 108, according to another embodiment of the present disclosure. The system 108 is functionally equivalent to the system 100 illustrated in FIGS. 3A and 3B. Common components between the system 100 and the system 108 are illustrated by the same reference numerals. However, in the system 108, the mechanical unit 202 includes a brake 602 and a pawl 604 normally disengaged from the brake 602, such that the brake 602 is normally stationary until the predetermined movement of the article of PPE 50. In FIG. 6A, the pawl 604 is illustrated as disengaged from the brake 602 and the brake 602 is normally stationary. The switching unit 204 is in the inactive configuration when the brake 602 is stationary. The brake 602 may be a component of an SRL.

The mechanical unit 202 further includes a plate 606 rotatable within a cavity 605 of the brake 602. Specifically, the plate 606 is rotatable about a shaft 608. The pawl 604 is also pivotable within the plate 606. The mechanical unit 202 further includes a spring 610 pivotable within the plate 606 and configured to apply a biasing force upon the pawl 604. The brake 602 further includes a plurality of teeth 612 extending into the cavity 605 of the brake 602.

Upon the predetermined movement of the article of PPE 50, the pawl 604 engages with the brake 602 thereby rotating the brake 602 by greater than a predetermined angle. Particularly, upon the predetermined movement of the article of PPE 50, the plate 606 rotates about the shaft 608 thereby creating centrifugal force causing the pawl 604 to pivot away from the plate 606 (against the biasing force of the spring 610) and engage the brake 602. In other words, upon the predetermined movement of the article of PPE 50, the pawl engages the brake 602 and rotates the brake 602 by greater than the predetermined angle.

In FIG. 6B, the pawl 604 is illustrated as engaged with the brake 602. In some cases, the predetermined angle may be equal to 90 degrees, or a quarter of a full turn of the brake 602. Upon rotation of the brake 602 by greater than the predetermined angle, the brake 602 mechanically actuates the switching unit 204 from the inactive configuration to the active configuration. In other words, upon occurrence of the fall event of the user, the pawl 604 rotates the brake 602 by greater than the predetermined angle thereby mechanically actuating the switching unit 204 from the inactive configuration to the active configuration. Therefore, upon rotation of the brake 602 by greater than the predetermined angle, the electronic circuit 206 is disposed in the on state and generates the output 10 indicative of the fall event of the user.

In some cases, upon a movement of the article of PPE 50, the pawl 604 engages the brake 602 and rotates the brake 602 by merely the predetermined angle. Such cases may correspond to situations where the article of PPE 50 is subjected to a significant force which may not correspond to the fall event of the user. Therefore, in cases where the brake 602 rotates by merely the predetermined angle, the electronic circuit 206 generates the output 10 indicative of the significant force applied to the article of PPE 50. Thereafter, the article of PPE 50 may need to be inspected or checked for further use. In some cases. rotation of the brake 602 by merely the predetermined angle may be a cumulative result of multiple pawl engagements with multiple small angular rotations that sum to the predetermined angle, indicating that the article of PPE 50 has experienced a cumulative force that may warrant inspection.

In some embodiments, such a mechanical unit (i.e., the mechanical 202 in FIGS. 6A and 6B) may be disposed on, but not limited to a leading edge SRL. In some cases, one such mechanical unit 202 may be disposed on a braking mechanism of the leading edge SRL and another such mechanical unit may be disposed on a shock pack of the leading edge SRL. In such cases, any of the mechanical units may generate the output 10.

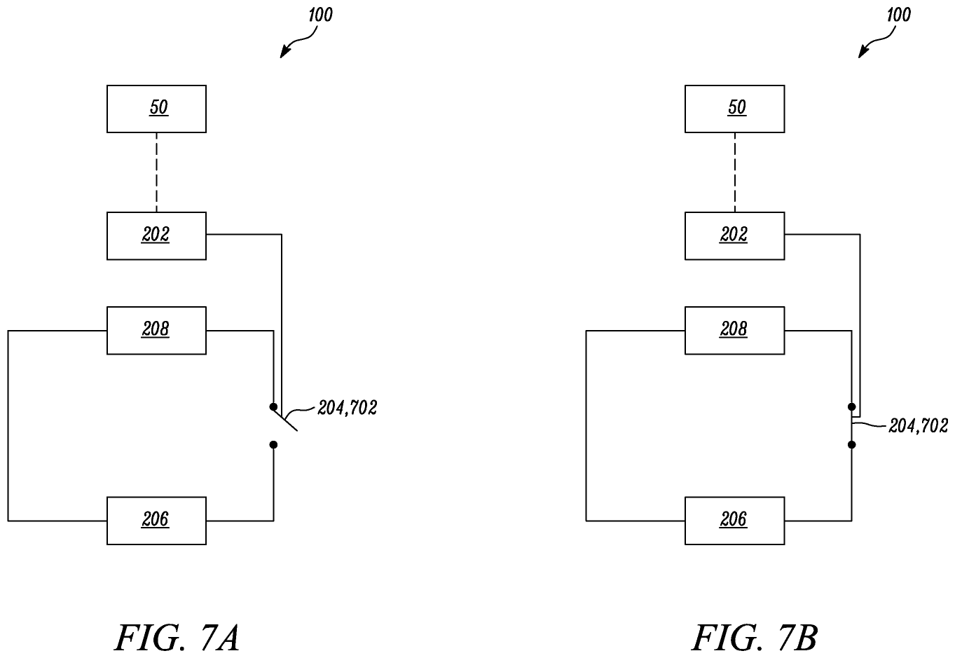

FIGS. 7A and 7B are schematic diagrams of the system 100 illustrated in FIGS. IA and 1B. according to another embodiment of the present disclosure. In this embodiment, the switching unit 204 includes a mechanical switch 702 configured to electrically couple and decouple the power source 208 to and from the electronic circuit 206 in the respective active and inactive configurations of the mechanical switch 702 or the switching unit 204. As illustrated in FIG. 7A, the mechanical switch 702 is open (i.e., inactive configuration) and as a result, the electronic circuit 206 is decoupled from the power source 208. As illustrated in FIG. 7B, upon the predetermined movement of the article of PPE 50, the mechanical switch 702 is closed (i.e., active configuration) and as a result, the electronic circuit 206 is coupled to the power source 208. Therefore, in the closed position of the mechanical switch 702 (i.e., the active configuration of the switching unit 204), the electronic circuit 206 is electrically powered by the power source 208.

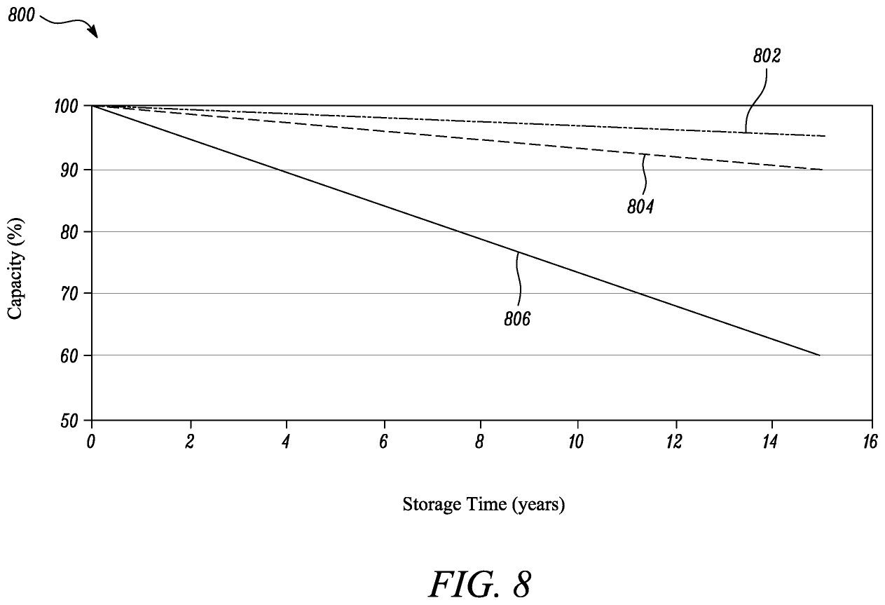

In some embodiments, the power source 208 includes a lithium iron disulfide battery having a shelf life of at least 10 years. In some cases, the lithium iron disulfide battery has the shelf life of about 15 years. The lithium iron disulfide battery provides a better performance at low ambient temperatures as well as high ambient temperatures. FIG. 8 is a graph 800 illustrating a capacity of the power source 208 (i.e., the lithium iron disulfide battery) versus storage time, according to an embodiment of the present disclosure. The capacity of the power source 208 is depicted in the ordinate in percentage. The storage time is depicted in the abscissa in years. The graph 800 includes curves 802, 804, and 806.

The curve 802 depicts a variation in the capacity of the power source 208 with the storage time at a temperature of 0 degree Celsius. The curve 804 depicts a variation in the capacity of the power source 208 with the storage time at a temperature of 20 degree Celsius. The curve 806 depicts a variation in the capacity of the power source 208 with the storage time at a temperature of 40 degree Celsius. From the graph 800, it is apparent that the power source 208 has a rated capacity of at least 50% for temperatures ranging between 0 degree Celsius to 40 degree Celsius. Further, the power source 208 has the rated capacity of at least 50% with the shelf life of at least 10 years.

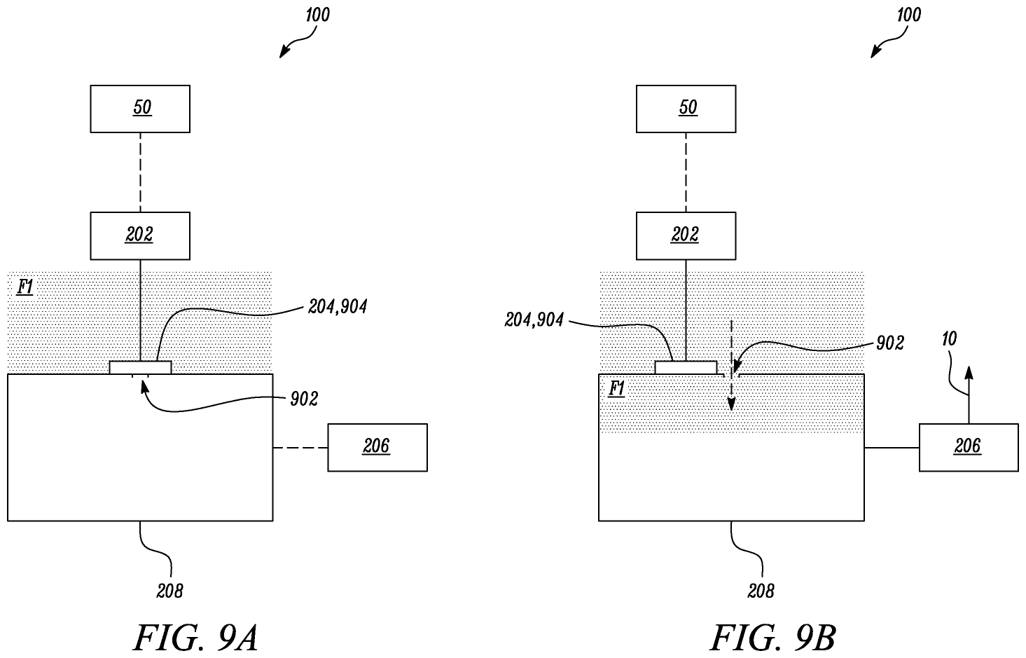

FIGS. 9A and 9B are schematic diagrams of the system 100 illustrated in FIGS. 1A and 1B. according to another embodiment of the present disclosure. In this embodiment, the switching unit 204 is configured to fluidly isolate the power source 208 from a fluid F1 in the inactive configuration and fluidly communicate the power source 208 with the fluid F1 in the active configuration. The power source 208 does not deliver electrical power to the electronic circuit 206 when the power source 208 is fluidly isolated from the fluid F1. Further, the power source 208 delivers electrical power to the electronic circuit 206 when the power source 208 is fluidly communicated with the fluid F1. The fluid F1 may be present outside the power source 208 or in ambient environment outside the power source 208, such that the switching unit 204 fluidly isolates the power source 208 from the fluid F1 in the inactive configuration of the switching unit 204.

In some embodiments, the power source 208 includes a zinc-air battery and the fluid F1 includes oxygen. Generally, the zinc-air battery is powered by oxidizing zinc with oxygen from the air. Alternatively, in some embodiments, the power source 208 includes a saltwater battery and the fluid F1 includes water. In such cases, the power source 208 is normally filled with salt.

In the illustrated embodiment of FIGS. 9A and 9B, the power source includes an opening 902. As illustrated in FIG. 9A, the switching unit 204 includes a tab 904 covering the opening 902 in the inactive configuration, such that the power source 208 is fluidly isolated from the fluid F1. As illustrated in FIG. 9B, upon the predetermined movement of the article of PPE 50, the mechanical unit 202 removes the tab 904 (i.e., the switching unit 204) from the power source 208 thereby fluidly communicating the power source 208 with the fluid F1. In other words, upon occurrence of the fall event of the user, the power source 208 fluidly communicates with the fluid F1 via the opening 902, and as a result, the power source 208 electrically powers the electronic circuit 206. Hence, upon fluid communication of the power source 208 with the fluid F1 via the opening 902, the electronic circuit 206 is disposed in the on state and generates the output 10 indicative of the fall event of the user.

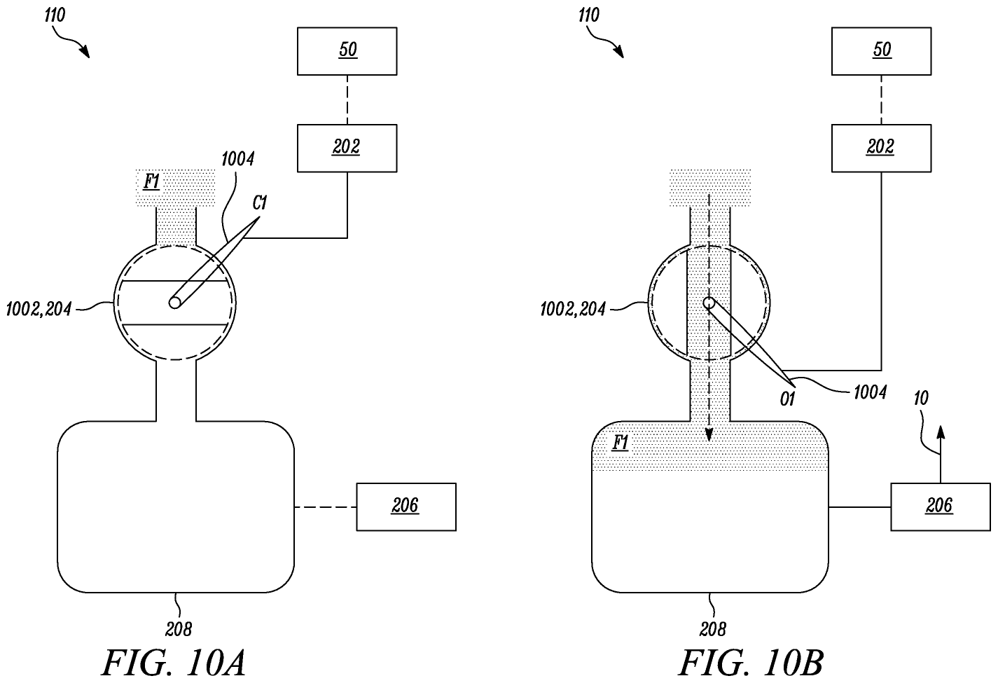

FIGS. 10A and 10B are schematic diagrams of a system 110, according to another embodiment of the present disclosure. The system 110 is substantially similar to the system 100 illustrated in FIGS. 9A and 9B. Common components between the system 100 and the system 110 are illustrated by the same reference numerals. However, in the system 110, instead of a tab, the switching unit 204 includes a valve 1002 configured to fluidly isolate the power source 208 from the fluid F1 in the inactive configuration and configured to fluidly communicate the power source 208 with the fluid F1 in the active configuration.

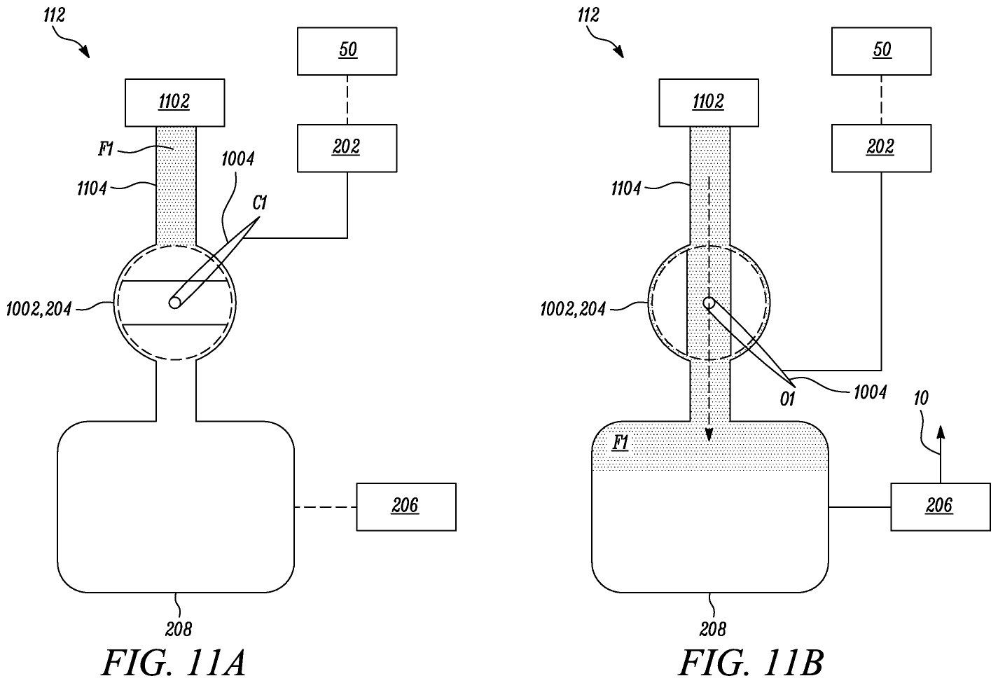

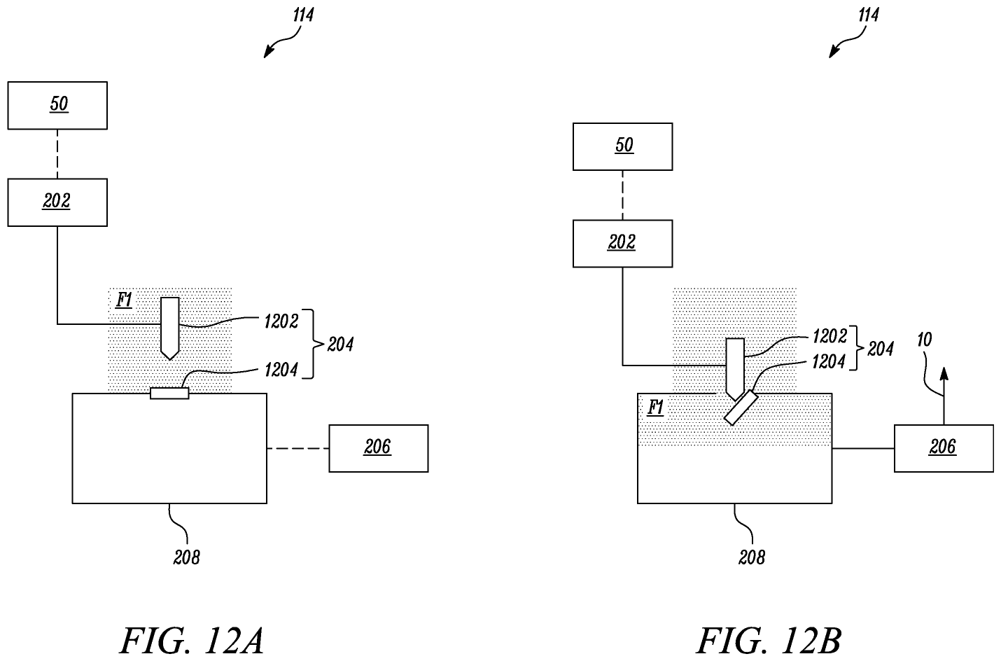

The valve 1002 comprises a valve body 1004 movable between a closed position C1 corresponding to the inactive configuration and an open position O1 corresponding to the active configuration. As illustrated in FIG. 10A, the valve body 1004 is normally disposed in the closed position C1 until the valve body 1004 is mechanically actuated to the open position O1 (illustrated in FIG. 10B). The valve 1002 fluidly isolates the power source 208 from the fluid F1 in the closed position of the valve body 1004. The mechanical unit 202 is mechanically coupled to the valve body 1004. As illustrated in FIG. 10B, upon the predetermined movement of the article of PPE 50, the mechanical unit 202 mechanically actuates the valve body 1004 to the open position O1 thereby fluidly communicating the power source 208 with the fluid F1. In other words, upon occurrence of the fall event of the user, the power source 208 fluidly communicates with the fluid F1 in the open position O1 of the valve body 1004 and as a result, the power source 208 electrically powers the electronic circuit 206. Hence, upon fluid communication of the power source 208 with the fluid F1 in the open position O1 of the valve body 1004, the electronic circuit 206 is disposed in the on state and generates the output 10 indicative of the fall event of the user. FIGS. 11A and 11B are schematic diagrams of a system 112, according to another embodiment of the present disclosure. The system 112 is substantially similar to the system 110 illustrated in FIGS. 10A and 10B. Common components between the system 110 and the system 112 are illustrated by the same reference numerals. However, the system 112 further includes a reservoir 1102 storing the fluid F1 therein and a fluid conduit 1104 extending between the reservoir 1102 and the power source 208. Further, the switching unit 204 is at least partially disposed within the fluid conduit 1104. The valve body 1004 fluidly isolates the power source 208 from the fluid conduit 1104 in the closed position C1. The valve body 1004 fluidly communicates the power source 208 with the fluid conduit 1104 in the open position O1. FIGS. 12A and 12B arc schematic diagrams of a system 114, according to another embodiment of the present disclosure. The system 114 is substantially similar to the system 100 illustrated in FIGS. 9A and 9B. Common components between the system 100 and the system 114 are illustrated by the same reference numerals. However, in the system 114, instead of a tab, the switching unit 204 includes a rupture tool 1202 mechanically coupled to the mechanical unit 202 and a seal 1204 disposed on the power source 208

As illustrated in FIG. 12A, the seal 1204 fluidly isolates the power source 208 from the fluid F1 in the inactive configuration of the switching unit 204. As illustrated in FIG. 12B, upon the predetermined movement of the article of PPE 50, the mechanical unit 202 mechanically actuates the rupture tool 1202. such that the rupture tool 1202 ruptures the seal 1204 in the active configuration of the switching unit 204 thereby fluidly communicating the power source 208 with the fluid F1. In other words, upon occurrence of the fall event of the user, the power source 208 fluidly communicates with the fluid F1 as the seal 1204 is ruptured by the rupture tool 1202. As a result, the power source 208 delivers electrical power to the electronic circuit 206 in order to generate the output 10 indicative of the fall event of the user.

With reference to FIGS. 1 to 12B, upon detecting the fall event of the user, the systems 100, 102, 104, 106, 108, 110, 112, 114 automatically send or generate the output 10 to a central server, a cloud, or a safety officer, or multiple destinations. Hence, the systems 100, 102, 104, 106, 108, 110, 112, 114 of the present disclosure can detect and alert the fall event of the user. The output 10 is generated even if the fall event is not known to any person other than the user. As the output 10 is generated as soon as the fall event is detected, the systems 100, 102, 104, 106, 108, 110, 112, 114 of the present disclosure may help the user to be rescued at a faster rate thereby preventing injury from happening in the first place. In other words. upon the fall event of the user, a timely and faster rescue and/or descent operation may be conducted. This may prevent the user against suspension trauma and injury after the fall event of the user. Further, as the output 10 is generated as soon as the fall event is detected, the system of the present disclosure may help the user to receive immediate and required medical attention in case of any critical injury. In other words. by automatically generating the output 10 upon detecting the fall event of the user, the systems 100, 102, 104, 106, 108, 110, 112, 114 of the present disclosure may protect the user from a life-threatening condition as he/she may receive the timely medical treatment.

Moreover, upon detecting the fall event of the user, the systems 100, 102, 104, 106, 108, 110, 112, 114 of the present disclosure may send real time alerts to the safety officer or the server without requiring additional infrastructure at a worksite. Further, as the electronic circuit 206 generates the output 10 only when the power source 208 electrically powers the electronic circuit 206 upon occurrence of the fall event of the user, the systems 100, 102, 104, 106, 108, 110, 112, 114 may have a long service life free of maintenance. Further, the systems 100, 102, 104, 106, 108, 110, 112, 114 may be integrated into a new or existing article of PPE used by the user without adding substantial cost. Moreover, the systems 100, 102, 104, 106, 108, 110, 112, 114 may provide a reliable means to generate the output 10 indicative of the fall event of the user.

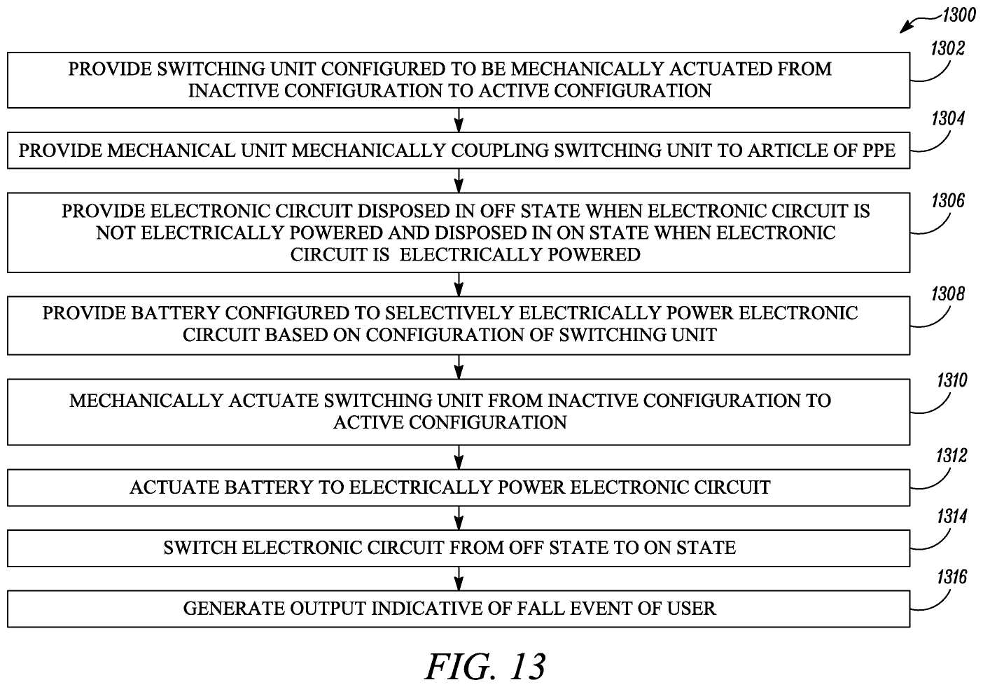

FIG. 13 is a flowchart of a method 1300 for detecting the fall event of the user using the article of PPE 50 (shown in FIG. 1A), according to an embodiment of the present disclosure. Referring to FIGS. 1A. 1B, and 13, at step 1302, the method 1300 includes providing the switching unit 204 configured to be mechanically actuated from the inactive configuration (illustrated in FIG. 1A) to the active configuration (illustrated in FIG. 1B).

At step 1304, the method 1300 includes providing the mechanical unit 202 mechanically coupling the switching unit 204 to the article of PPE 50. At step 1306, the method 1300 includes providing the electronic circuit 206 disposed in the off state when the electronic circuit 206 is not electrically powered and disposed in the on state when the electronic circuit 206 is electrically powered. At step 1308, the method 1300 includes providing the power source 208 configured to selectively electrically power the electronic circuit 206 based on the configuration of the switching unit 204.

At step 1310, the method 1300 includes mechanically actuating. via the mechanical unit 202, the switching unit 204 from the inactive configuration to the active configuration upon the predetermined movement of the article of PPE 50 corresponding to the fall event of the user. At step 1312, the method 1300 includes actuating, via the switching unit 204, the power source 208 to electrically power the electronic circuit 206 upon being mechanically actuated from the inactive configuration to the active configuration. At step 1314, the method 1300 includes switching the electronic circuit 206 from the off state to the on state upon being electrically powered by the power source 208. At step 1316, the method 1300 includes generating, via the electronic circuit 206, the output 10 indicative of the fall event of the user upon being switched from the off state to the on state.

With reference to FIGS. 3A to 4B, and 13, the method 1300 further includes detaching the mechanical unit 202 (i.e., the ferrule 304 in FIGS. 3A and 3B, and the pin 404 in FIGS. 4A and 4B) from the article of PPE 50 (i.e., the SRL 300 in FIGS. 3A and 3B, and the lanyard 400 in FIGS. 4A and 4B) upon the predetermined movement of the article of PPE 50. In some embodiments, the method 1300 further includes deforming the mechanical unit 202 upon the predetermined movement of the article of PPE 50.

With reference to FIGS. 5A. 5B, and 13, the method 1300 further includes tearing the mechanical unit 202 (i.e., the webbing 504) upon the predetermined movement of the article of PPE 50 (i.e., the lanyard 500). The mechanical unit 202 mechanically actuates the switching unit 204 from the inactive configuration to the active configuration upon tearing of the mechanical unit 202.

With reference to FIGS. 6A. 6B, and 13, the method 1300 further includes rotating the pawl 604 to engage with the brake 602 upon the predetermined movement of the article of PPE 50. Upon engagement of the pawl 604 with the brake 602, the pawl 604 rotates the brake 602 by greater than the predetermined angle. Upon rotation of the brake 602 by greater than the predetermined angle, the brake 602 mechanically actuates the switching unit 204 from the inactive configuration to the active configuration.

With reference to FIGS. 7A, 7B, and 13, actuating the power source 208 further includes electrically coupling, via the switching unit 204 (i.e., the mechanical switch 702), the power source 208 to the electronic circuit 206 in the active configuration of the switching unit 204.

With reference to FIGS. 9A to 12B, and 13, actuating the power source 208 further includes fluidly communicating, via the switching unit 204, the power source 208 with the fluid F1 in the active configuration of the switching unit 204.

With reference to FIGS. 9A, 9B, and 13, mechanically actuating the switching unit 204 further includes removing, via the mechanical unit 202, the tab 904 from the power source 208 thereby fluidly communicating the power source 208 with the fluid F1.

With reference to FIGS. 10A to 11B, and 13, mechanically actuating the switching unit 204 further includes mechanically actuating, via the mechanical unit 202, the valve body 1004 from the closed position C1 to the open position O1 thereby fluidly communicating the power source 208 with the fluid F1.

With reference to FIGS. 12A, 12B, and 13, mechanically actuating the switching unit 204 further includes mechanically actuating, via the mechanical unit 202, the rupture tool 1202, such that the rupture tool 1202 ruptures the seal 1204 thereby fluidly communicating the power source 208 with the fluid F1.

With reference to FIGS. 1A to 2B, and 13, in some embodiments, the method 1300 further includes determining, via the electronic circuit 206, the location of the fall event of the user. The method 1300 further includes embedding, via the electronic circuit 206, the location of the fall event of the user in the output 10. The method 1300 further includes transmitting, via the electronical circuit 206, the output 10 to the predefined destination 24.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A system for detecting a fall event of a user using an article of personal protective equipment (PPE), the system comprising:
a switching unit configured to be mechanically actuated from an inactive configuration to an active configuration, wherein the switching unit is normally disposed in the inactive configuration until the switching unit is mechanically actuated to the active configuration;
a mechanical unit mechanically coupling the switching unit to the article of PPE, wherein the mechanical unit mechanically actuates the switching unit from the inactive configuration to the active configuration upon a predetermined movement of the article of PPE corresponding to the fall event of the user;
an electronic circuit disposed in an off state when the electronic circuit is not electrically powered and disposed in an on state when the electronic circuit is electrically powered, wherein, in the on state, the electronic circuit generates an output indicative of the fall event of the user; and
a power source configured to selectively electrically power the electronic circuit based on a configuration of the switching unit, wherein, in the inactive configuration of the switching unit, the power source does not electrically power the electronic circuit, such that the electronic circuit is in the off state, wherein, in the active configuration of the switching unit, the power source electrically powers the electronic circuit, such that the electronic circuit switches from the off state to the on state and generates the output.

2. The system of claim 1, wherein the mechanical unit is configured to detach from the article of PPE upon the predetermined movement of the article of PPE, and wherein the mechanical unit mechanically actuates the switching unit from the inactive configuration to the active configuration upon detachment of the mechanical unit from the article of PPE.

3. The system of claim 2, wherein the article of PPE comprises a self-retracting lifeline (SRL) comprising a snap hook, wherein the mechanical unit comprises a ferrule normally attached to the snap hook, and wherein the ferrule detaches from the snap hook upon the predetermined movement of the article of PPE.

4. The system of claim 2, wherein the article of PPE comprises a lanyard comprising a connector, wherein the mechanical unit comprises a pin normally attached to the connector, and wherein the pin detaches from the connector upon the predetermined movement of the article of PPE.

5. The system of claim 1, wherein the mechanical unit is configured to deform upon the predetermined movement of the article of PPE, and wherein the mechanical unit mechanically actuates the switching unit from the inactive configuration to the active configuration upon deformation of the mechanical unit.

6. The system of claim 1, wherein the mechanical unit comprises a webbing attached to the article of PPE, wherein the switching unit is in the inactive configuration when the webbing is normally disposed in an intact configuration, wherein the webbing at least partially tears from the intact configuration upon the predetermined movement of the article of PPE, and wherein the webbing mechanically actuates the switching unit from the inactive configuration to the active configuration upon tearing from the intact configuration.

7. The system of claim 1, and wherein the mechanical unit comprises:
a brake; and
a pawl normally disengaged from the brake, such that the brake is normally stationary until the predetermined movement of the article of PPE, wherein, upon the predetermined movement of the article of PPE, the pawl engages with the brake thereby rotating the brake by greater than a predetermined angle;
wherein the switching unit is in the inactive configuration when the brake is stationary, wherein, upon rotation of the brake by greater than the predetermined angle, the brake mechanically actuates the switching unit from the inactive configuration to the active configuration.

8. The system of claim 1, wherein the switching unit comprises a mechanical switch configured to electrically couple and decouple the power source to and from the electronic circuit in the respective active and inactive configurations of the mechanical switch.

9. The system of claim 1, wherein the power source comprises a lithium iron disulfide battery having a shelf life of at least 10 years.

10. The system of claim 1, wherein the power source has a rated capacity of at least 50% for temperatures ranging between 0 degree Celsius to 40 degree Celsius.

11. The system of claim 1, wherein the switching unit is configured to fluidly isolate the power source from a fluid in the inactive configuration and fluidly communicate the power source with the fluid in the active configuration, wherein the power source does not deliver electrical power to the electronic circuit when the power source is fluidly isolated from the fluid, and wherein the power source delivers electrical power to the electronic circuit when the power source is fluidly communicated with the fluid.

12. The system of claim 11, wherein the power source comprises an opening, wherein the switching unit comprises a tab covering the opening in the inactive configuration, such that the power source is fluidly isolated from the fluid, and wherein, upon the predetermined movement of the article of PPE, the mechanical unit removes the tab from the power source thereby fluidly communicating the power source with the fluid. 13-17. (Canceled)

18. The system of claim 1, wherein the mechanical unit comprises at least one of a mechanical linkage, a gear drive, a friction drive, a cable, and a connecting cord.

19. The system of claim 1, wherein the electronic circuit comprises at least one electronic component configured to generate the output, and wherein the at least one electronic component comprises one or more of a speaker, a vibration device, a light emitting diode, and a buzzer.

20. The system of claim 1, wherein the electronic circuit comprises a processor and a memory communicably coupled to the processor and configured to store at least one parameter, and wherein the at least one parameter comprises one or more of a serial number associated with the article of PPE, a unique identification number of the user, one or more instructions executable by the processor, and one or more destination addresses of the output.

21-22. (Canceled)

23. The system of claim 1, wherein the electronic circuit is further configured to:
determine a location of the fall event of the user based on at least one of Bluetooth direction finding, geofencing, and Wi-Fi connection with one or more access points: and
transmit the output to a predefined destination, wherein the location of the fall event of the user is embedded in the output.

24. The system of claim 1, wherein the output comprises at least one of an audio signal, a text message, a visual signal, and a haptic signal.

25. The system of claim 1, further comprising an article of PPE mechanically coupled to the mechanical unit, the article of PPE comprising fall protection equipment.

26. (canceled)

27. An article of PPE comprising the system of claim 1.

28. A method for detecting a fall event of a user using an article of personal protective equipment (PPE), the method comprising:
providing a switching unit configured to be mechanically actuated from an inactive configuration to an active configuration, and wherein the switching unit is normally disposed in the inactive configuration until the switching unit is mechanically actuated to the active configuration;
providing a mechanical unit mechanically coupling the switching unit to the article of PPE;
providing an electronic circuit disposed in an off state when the electronic circuit is not electrically powered and disposed in an on state when the electronic circuit is electrically powered:
providing a power source configured to selectively electrically power the electronic circuit based on a configuration of the switching unit, wherein, in the inactive configuration of the switching unit, the power source does not electrically power the electronic circuit, such that the electronic circuit is in the off state:
mechanically actuating, via the mechanical unit, the switching unit from the inactive configuration to the active configuration upon a predetermined movement of the article of PPE corresponding to the fall event of the user;
actuating, via the switching unit, the power source to electrically power the electronic circuit upon being mechanically actuated from the inactive configuration to the active configuration:
switching the electronic circuit from the off state to the on state upon being electrically powered by the power source; and
generating, via the electronic circuit, an output indicative of the fall event of the user upon being switched from the off state to the on state.

29-39. (canceled)
